(19) United States
(12) Patent Application Publication
(10) Pub. No.: US 2011/0282627 A1
(43) Pub. Date: Nov. 17, 2011

(54) METHOD AND SERVER OF DETERMINING ADVISORY SAFETY SPEED BASED ON ROAD SURFACE STATES AND STATISTICAL TRAFFIC CONDITIONS

(75) Inventors: Jeong Ah JANG, Daejeon (KR); Hyun Suk KIM, Daejeon (KR); Hae Sook JEON, Daejeon (KR)

(73) Assignee: Electronics and Telecommunications Research Institute, Daejeon (KR)

(21) Appl. No.: 13/107,336

(22) Filed: May 13, 2011

(30) Foreign Application Priority Data
May 13, 2010 (KR) 10-2010-0045118

(51) Int. Cl. G06F 17/18

(52) U.S. Cl. 702/179

(57) ABSTRACT

Provided are a method and an apparatus of determining safety speed based on road surface states and statistical traffic conditions. The exemplary embodiment of the present invention provides a driver with the advisory safety speed according to the speed information, the positional information, and the road surface states, or the like, collected from the GNSS receiver and the probe vehicle capable of performing the wireless communications, thereby making it possible to contribute to the traffic safety. In addition, the exemplary embodiment of the present invention can allow a driver to lower the travel speed of a vehicle by actively coping with a traffic jam, an occurrence of an accident, rapid weather changes, or the like, thereby making it possible to contribute to the occurrence prevention of a secondary accident, the alleviation of a traffic jam, or the like.

### CROSS-REFERENCE TO RELATED APPLICATIONS

This application claims priority under 35 U.S.C. §119 to Korean Patent Application No. 10-2010-0045118, filed on May 13, 2010, in the Korean Intellectual Property Office, the disclosure of which is incorporated herein by reference in its entirety.

### TECHNICAL FIELD

The present invention relates to a method and an apparatus of determining advisory safety speed, and more particularly, a method and an apparatus of determining advisory safety speed based on road surface states and statistical traffic conditions.

### BACKGROUND

As the related art, there are a method of deriving safe driving based on conditions in front of a vehicle, a method of maintaining relative speed and safety speed using a yaw rate sensor at a curved line, a road visibility warning system using visibility and pavement sensors, a system of determining a safety distance of a vehicle from a speed of a vehicle and a headway time between back and forth vehicles, or the like. However, firstly, the above-mentioned related arts have a problem in that they do not consider road surface states, road surface frictional coefficients, and traffic condition statistical values. Secondly, the related arts provide the results of determining the safety distance, not the safety speed, such that it is difficult for a driver to intuitively perceive the safety distance and actually use it. Thirdly, the related arts have a problem in that they calculate a safety distance without considering various variables such as a driver's perception response time, a time to collision, or the like.

### SUMMARY

An exemplary embodiment of the present invention provides a server of determining safety speed based on road surface states and statistical traffic conditions, including: a receiver receiving real-time vehicle travel information and road surface states; a traffic information processor calculating traffic condition statistical values for each section and for each time based on the vehicle travel information; a road frictional coefficient estimator estimating road frictional coefficients based on the road surface states and the calculated traffic condition statistical values; and an advisory safety speed determining unit determining safety speed for each section and for each time by using the calculated traffic condition statistical values, the estimated road frictional coefficients, a driver's perception response time, and a time to collision (TTC).

The traffic information processor may include: a division module dividing a collection section by mapping a vehicle position with section information for each time from the vehicle travel information; and a calculation module calculating traffic condition statistical values for each collection section based on the vehicle travel information.

The vehicle travel information may be at least one of a vehicle id, a collection time, a speed, a position, and acceleration and deceleration.

The calculated traffic condition statistical value may be at least any one of an average speed, a median of speed, 85% of speed, and a standard deviation of speed.

The road surface state may be at least any one of dry, wet, hydroplaning, snow, freezing, mist, road frictional force, obstacles, and front road surface state.

The estimated road frictional coefficient may be small with the increase in the vehicle speed.

The advisory safety speed determining unit may determine an advisory safety speed by further using at least any one of a headway distance, a statistical headway distance, a minimum safety distance, inclination, and gravity acceleration.

The statistical headway distance may be obtained by multiplying the TTC by the traffic condition statistical values and adding the headway distance thereto.

The advisory safety speed may be determined so that the minimum safety distance becomes the statistical headway distance.

The server of determining safety speed may further include a transmitter transmitting the advisory safety speed.

Another exemplary embodiment of the present invention provides a method of determining safety speed based on road surface states and statistical traffic conditions performed by a server of determining safety speed, the method including: receiving real-time vehicle travel information and road surface states; calculating traffic condition statistical values for each section and for each time based on the vehicle travel information; estimating road frictional coefficients based on the road surface states and the calculated traffic condition statistical values; and determining safety speed for each section and for each time by using the calculated traffic condition statistical values, the estimated road frictional coefficients, a driver's perception response time, and a time to collision (TTC).

The calculating may include: dividing a collection section by mapping a vehicle position with section information for each time from the vehicle travel information; and calculating traffic condition statistical values for each collection section based on the vehicle travel information.

The vehicle travel information may be at least one of a vehicle id, a collection time, a speed, a position, and acceleration and deceleration.

The calculated traffic condition statistical value may be at least any one of an average speed, a median of speed, 85% of speed, and a standard deviation of speed.

The road surface state may be at least any one of dry, wet, hydroplaning, snow, freezing, mist, road frictional force, obstacles, and front road surface state.

The estimated road frictional coefficient may be small with the increase in the vehicle speed.

The determining may determine an advisory safety speed by further using at least any one of a headway distance, a statistical headway distance, a minimum safety distance, inclination, and gravity acceleration.

The statistical headway distance may be obtained by multiplying the TTC by the traffic condition statistical values and adding the headway distance thereto.

The advisory safety speed may be determined so that the minimum safety distance becomes the statistical headway distance.

The method of determining safety speed may further include transmitting the advisory safety speed.

Other features and aspects will be apparent from the following detailed description, the drawings, and the claims.

### BRIEF DESCRIPTION OF THE DRAWINGS

FIG. 1 is a configuration diagram of a system of determining safety speed based on road surface states and statistical traffic conditions.

FIG. 2 is a configuration diagram of a server of determining safety speed based on road surface states and statistical traffic conditions.

FIG. 3 is a block diagram of a method of determining safety speed based on road surface states and statistical traffic conditions.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

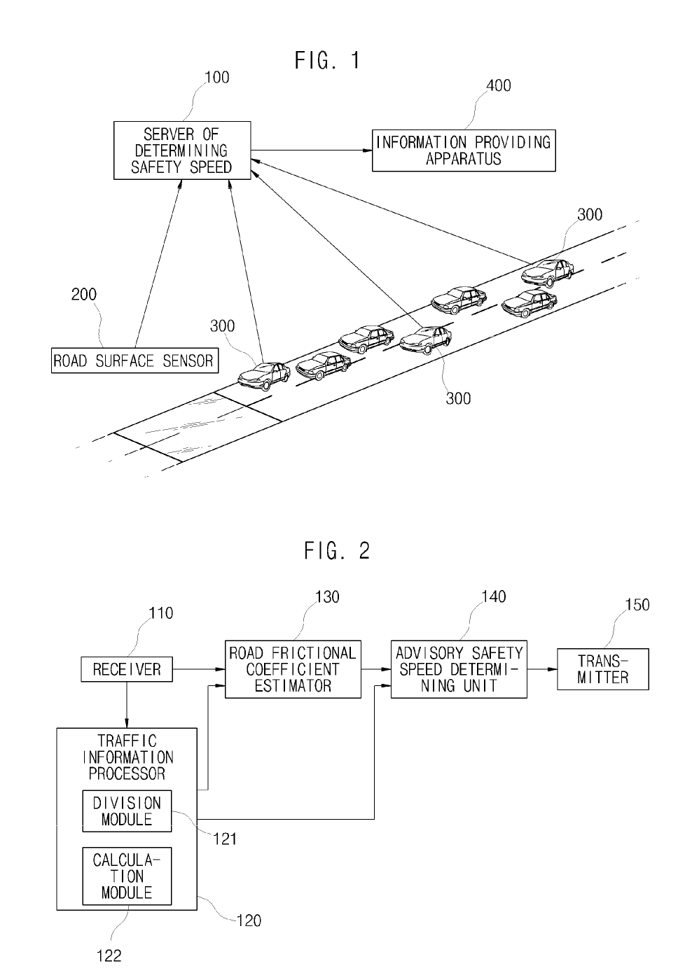

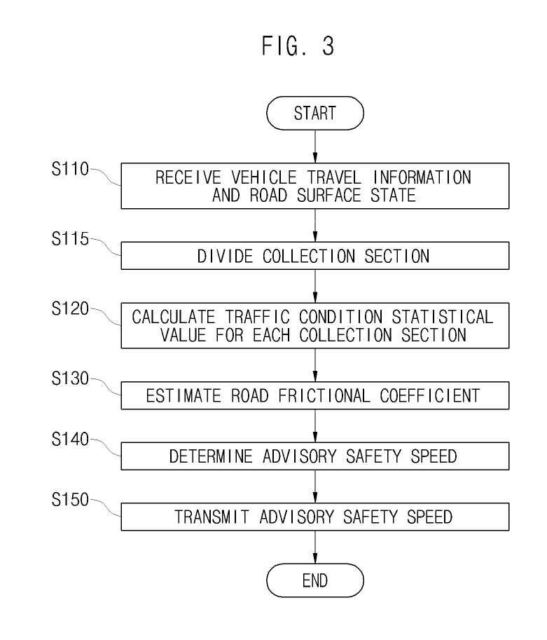

FIG. 1 is a configuration diagram of a system of determining safety speed based on road surface states and statistical traffic conditions, FIG. 2 is a configuration diagram of a server of determining safety speed based on road surface states and statistical traffic conditions, and FIG. 3 is a block diagram of a method of determining safety speed based on road surface states and statistical traffic conditions.

According to the exemplary embodiment of the present invention, a server of determining safety speed may receive road surface states and vehicle travel information in real time. That is, the information on the road surface states (dry, wet, hydroplaning, snow, freezing, mist, or the like) may be detected for each time and for each section. These road surface states, which have an effect on the vehicle driving, are important information required in order to prevent a risk occurring when a vehicle is driven. The road surface states may be largely collected from detectors mounted on a road side in real time or sensors mounted in a vehicle on the road. Further, the vehicle travel information (the position, speed, acceleration and deceleration information, or the like, of a vehicle) may be collected from a probe vehicle mounted with a GNSS and a wireless communication device in real time.

For example, when the front road surface states are in a sliding state due to freezing or snow in the state where the vehicle speed is fast, there is a need to previously prevent accidents such as bump by appropriately lowering a speed limit even though the speed limit is uniformly defined by 100 km/h. The advisory safety speed, which is a concept of a speed limit according to the changes in road states and traffic conditions, is intuitively recognized by a driver, such that the driver decelerates the current vehicle speed to the advisory safety speed, thereby making it possible to promote the road safety. That is, the advisory safety speed, which is “a maximum road travel speed of a vehicle based on the changes in traffic conditions and road surface states for a single section over time,” is determined by using an inter-vehicle safety distance, traffic conditions statistical values, information on road surface states, or the like.

As described above, the exemplary embodiment of the present invention determines the safety speed, not the safety distance, based on the road surface states and the statistical traffic conditions in front of the vehicle, and allows a driver to easily perceive and use the safety speed, such that the driver can lower the travel speed of the vehicle. First, the exemplary embodiment of the present invention calculates the safety speed required for each vehicle from the server, based on road surface frictional coefficients due to the road surface states and traffic condition statistical values at that time. The exemplary embodiment of the present invention individually provides a calculated advisory safety speed to vehicles through terminals for each vehicle or simultaneously provides it to a number of vehicles through a variable message system. Second, unlike a method of informing a driver of the determined safety distance or controlling a vehicle, the exemplary embodiment of the present invention determines an appropriate safety speed and informs a driver of it, thereby allowing the driver to easily perceive it and lower the vehicle speed based on it. Third, the exemplary embodiment of the present invention provides a method of determining advisory safety speed based on various variables (driver's perception response time, time to collision, statistical speed values, inter-vehicle safety distance, inclination, road surface frictional coefficients, or the like). The exemplary embodiment of the present invention may be easily used by providing important Equations by way of example.

Referring to FIG. 1, a system of determining safety speed based on road surface states and statistical traffic conditions is configured to include a probe vehicle 300, road surface sensors 200, a server 100 of determining safety speed, and an information providing apparatus 400.

The probe vehicle 300 is mounted with a global navigation satellite system (GNSS) (a global positioning system (GPS), or the like) receiver capable of recognizing positional information and a wireless communication transmitter capable of transferring information on a vehicle to a server 100 of determining safety speed. The probe vehicle 300 collects vehicle travel information in real time while travelling the road and transfers it to the server 100 of determining safety speed, such that the server 100 can determine traffic conditions in real time. In addition, the probe vehicle 300 may be attached with sensors detecting the road surface states. The sensors attached to the vehicle may detect a road surface frictional force, obstacles in front of a road, front road surface states, or the like, through tires. The information is transmitted to the server 100 of determining safety speed through an electronic control unit (ECU) or a terminal of the probe vehicle 300.

The road surface sensors 200 are mounted on a road side to collect the information on the road surface states such as wet, dry, hydroplaning, snow, freezing, mist, or the like, in real time. The road surface sensors 200 mounted on the road side may be a radar sensor, a road environment sensor (convergence sensor such as temperature, humidity, wind direction, or the like), or the like. The sensor may be changed according to a technological advancement and the exemplary embodiment of the present invention is not limited to a specific collection technology manner.

The server 100 of determining safety speed receives the vehicle travel information (travel time, position, speed, acceleration and deceleration speed, or the like, of a vehicle) and the information on the road surface states (road frictional force, obstacles, front road surface state, or the like) from the probe vehicle 300 in real time. In addition, the server 100 of determining safety speed may receive the vehicle travel information from the probe vehicle 300 and the road surface states (wet, dry, hydroplaning, snow, freezing, mist, or the like) from the road surface sensor 200 in real time. The traffic condition statistical values are calculated based on the received information, the road frictional coefficients are estimated from the calculated statistical values and the information on the road surface states, and the safety speed is determined for each time and for each section by using the calculated traffic condition statistical values and the estimated road frictional coefficients. The server 100 may be classified into a road side equipment (RSE) and a central server mounted on the road side according to the position.

The information providing apparatus 400 receives the advisory safety speed determined by the server 100 and displays it. A display device may be a driver terminal, a variable message system, an Internet, broadcasting, or the like. The exemplary embodiment of the present invention is not limited to a specific method and medium for the information providing apparatus 400.

Referring to FIG. 2, the server 100 of determining safety speed based on the road surface information and the statistical traffic conditions according to the exemplary embodiment of the present invention is configured to include a receiver 110, a traffic information processor 120, a road frictional coefficient estimator 130, an advisory safety speed determining unit 140, and a transmitter 150. The receiver 110 may receive the vehicle travel information and the road surface information from the probe vehicle 300 in real time. In addition, the receiver 110 may receive the vehicle travel information from the probe vehicle 300 and the information on the road surface states from the road surface sensor 200 in real time.

The traffic information processor 120 calculates the traffic condition statistical values for each section and for each time, based on the real-time vehicle travel information (vehicle id, collection time, speed, position, acceleration and deceleration speed, or the like) received in the receiver 110. The traffic information processor 120 includes a division module 121 and a calculation module 122. The division module 121 divides a collection section by mapping the vehicle position from the vehicle travel information with section information for each time. The calculation module 122 calculates the traffic condition statistical values for the collection section based on the vehicle travel information. The traffic condition statistical values may be an average speed, a median of speed, 85% of speed, a standard deviation of speed, or the like, based on instantaneous velocity Ui for each time of i of the probe vehicle 300 in the collection section. The traffic condition statistical values are used at the time of determining the advisory safety speed and may be corrected by the user according to the traffic conditions and the road conditions. For example, the input and output of the traffic information processor 120 are as follows.

Input=Vehicle id, Collection Time, Speed, Position

Output=Average Speed, Median of Speed, 85% of Speed, Standard Deviation of Speed

The road frictional coefficient estimator 130 estimates the road frictional coefficients based on the road surface states (dry, wet, hydroplaning, snow, freezing, mist, or the like) collected from the road surface center and the statistical values calculated from the traffic information processor 120. In addition, the road frictional coefficients may be estimated based on the statistical values calculated from the traffic information processor 120 and the road surface states (road frictional force, obstacles, front road surface states, or the like) collected from the probe vehicle 300. In this case, the statistical values may use the average speed of the vehicle. That is, the road frictional coefficient estimator 130 estimates a unified frictional coefficient by using the road surface states and various traffic condition statistical values. In addition, the frictional coefficient may be estimated by using a pavement material, pollution conditions, a shape of vehicle tire, a rubber state, and a load related value. The estimated road frictional coefficient may be reduced with the increase in the vehicle speed. For example, the input and output of the road frictional coefficient estimator 130 are as follows.

Input=Road Surface State (dry, wet, hydroplaning, snow, freezing, mist, road frictional force, obstacles, front road surface states, or the like), Vehicle Average Speed

Output=Road Frictional Coefficient

For example, the estimated road frictional coefficient is as follows.

TABLE 1

| | Road Frictional Coefficient (Reduced With |
|---|---|
| Road Surface State | Increase In Average Speed) |
| Dry Asphalt Road Surface | 0.8 to 0.9 |
| Wet Asphalt Road Surface | 0.3 to 0.5 |
| Freezing Road Surface | 0.1 to 0.2 |

The advisory safety speed determining unit 140 determines the advisory safety speed for each time and for each section based on the traffic condition statistical values calculated from the traffic information processor 120, the road frictional coefficient estimated from the road frictional coefficient estimator 130, the driver's perception response time, and the time to collision (TTC). The input and output of the advisory safety speed determining unit 140 are as follows.

Input=Traffic Condition Statistical Value (Average Speed, Median of Speed, 85% of Speed, Standard Deviation of Speed, or the like), Road Surface Frictional Coefficient

Output=Advisory Safety Speed For Each Time and For Each Section

The advisory safety speed may be determined by using the traffic condition statistical values, the road surface frictional coefficient, the driver's perception response time, the TTC, the headway distance, the statistical headway distance, the minimum safety distance, the inclination, the gravity acceleration, or the like. That is, the advisory safety speed may be obtained by the following function.

Advisory Safety Speed=f (traffic condition statistical values, road surface frictional coefficient, driver's perception response time, TTC, headway distance, statistical headway distance, minimum safety distance, inclination, gravity acceleration, or the like).

As an example, the advisory safety speed may be calculated as follows.

In order to avoid the collision with a following vehicle when the preceding vehicle is decelerated at a specific time, the following vehicle should be travelled at the headway distance exceeding the minimum safety distance or the escorting vehicle should be more decelerated. Therefore, the problem is caused in the case where the statistical headway distance H from the escorting vehicle at the braking time of the preceding vehicle is smaller than the minimum safety distance.

In this case, the statistical headway distance H from the escorting vehicle, which is a safety distance based on the general time to collision (TTC), may be determined by the following Equation 1 by using the value u(k) of the statistical vehicle speed of k time.

H=TTC×u(k)+L [Equation 1]

H=Statistical Headway Distance (m)

TTC: Time to Collision (Sec)

u(k): Traffic Condition Statistical Value (km/h)

L: Headway Distance (Inter-Vehicle Safety Distance). Headway Distance When Vehicle Stops (Vehicle Length+Inter-Vehicle Distance) (m)

In addition, an MSD, which is a minimum safety distance of a specific vehicle, may be determined by the following Equation 2.

$$MSD = u \times {t}_{PRT} + \frac{{u}^{2}}{2 \times g \times ( f + G )} \qquad [ Equation 2 ]$$

MSD=Minimum Safety Distance (m)

u: Advisory Safety Speed (m/sec)

tPRT: Driver's Perception Response Time (Sec)

f: Road Surface Frictional Coefficient

g: Gravity Acceleration. 9.8 m/sec2

G: Inclination (%)

When the statistical headway distance is smaller than the minimum safety distance, there may be a risk of collision. Therefore, the advisory safety speed can be obtained by making the minimum safety distance (MSD) equal to the inter-vehicle statistical headway distance (H). That is, if Equation 1 is equal to Equation 2 and the value for the advisory safety speed u is obtained, the following Equation 3 is obtained.

$$TTC \times u ( k ) \times \frac{1000 \times m}{3600 \times sec} + L = u \times {t}_{PRT} + \frac{{u}^{2}}{2 \times g \times ( f + G )} \qquad [ Equation 3 ]$$

Since a unit of u(k) is km/h, in order to convert km/h into m/sec, the u(k) is multiplied by 1000/3600. The following Equation 4 is obtained by transposing and arranging the u(k).

u²+2g(f+G)t_{PRT}×u−(2g(f+G)(TTC×u(k)/3.6+L)=0 [Equation 4]

In Equation 4, in order to obtain a solution for u, if Equation 4 is substituted into a quadratic formula, the following Equation 5 is obtained.

$$u = \frac{\begin{matrix}- 2 g ( f + G ) {t}_{PRT} + \\ \sqrt{{( - 2 g ( f + G ) {t}_{PRT} )}^{2} + 8 g ( f + G ) ( TTC \times u ( k ) / 3.6 + L )}\end{matrix}}{2} \qquad [ Equation 5 ]$$

Since the u is m/sec, if Equation 5 is arranged by multiplying 3.6 by u in order to convert m/sec into km/h capable of being easily perceived by the user, the following Equation is obtained.

$$u = [ - {t}_{PRT} + \sqrt{{t}_{PRT}^{2} + \frac{2 \times ( TTC \times u ( k ) / 3.6 + L )}{g \times ( f + G )}} ] \times [ g \times ( f + G ) ] \times 3.6 \qquad [ Equation 6 ]$$

The advisory safety speed according to the exemplary embodiment of the present invention may be determined by Equation 6. In addition, the advisory safety speed may be determined by using the additional contents by the real-time detection data of the road.

The transmitter 150 transmits the advisory safety speed determined in the advisory safety speed determining unit 140 to the information providing apparatus 400. The information providing apparatus 400 may be the driver terminal, the variable message system, the Internet, and the broadcasting, or the like. The advisory safety speed is information that may be referenced to the driver in the vehicle being driven according to the spatially, temporally changing road and the road surface information conditions. When the driver vehicle is mounted with a telematics terminal, a smart terminal-based location-based service (LBS) program, or the like, the driver can confirm the advisory safety speed in the vehicle in real time. In addition, the driver can receive the advisory safety speed from the variable message system of the road side, the broadcasting, and the Internet.

The exemplary embodiment of the present invention handles a method of determining the safety speed capable of being processed in the server using the advisory information capable of being provided to the driver, but the wireless communication method for collection, the information providing medium (terminal, variable message system, or the like), the information providing communication method, or the like, are not limited.

Referring to FIG. 3, in the method of determining safety speed based on the road surface information and the statistical traffic conditions according to the present invention, the server 100 of determining safety speed first receives the real-time vehicle travel information and the road surface states (S110). The vehicle travel information may be received from the probe vehicle 300 and the road surface states may be received from the probe vehicle 300 or the road surface sensors 200. An example of the vehicle travel information may include vehicle id, collection time, speed, position, acceleration and deceleration, or the like, and an example of the road surface states may include dry, wet, hydroplaning, snow, freezing, mist, road frictional force, obstacles, front road surface states, or the like.

Next, the server maps the vehicle position with the section information for each time based on the real-time vehicle travel information to divide the collection section (S115).

Next, the server calculates the traffic condition statistical values for each collection section (S120). The traffic condition statistical values may be an average speed, a median of speed, 85% of speed, a standard deviation of speed, or the like, based on instantaneous velocity Ui for each time of i of the probe vehicle 300 in the collection section. One of the values used at the time of calculating the advisory safety time is a value correctable by the user according to the traffic conditions and the road conditions. For example, the calculating of the traffic condition statistical values uses the vehicle id, the collection time, the speed, the position, or the like, as the input and uses an average speed, a median of speed, 85% of speed, a standard deviation of speed as the output.

Next, the server estimates the road frictional coefficients based on the road surface states (wet, dry, hydroplaning, snow, freezing, mist, or the like) received from the road surface sensors and the traffic condition statistical values (S130). Further, the road frictional coefficients may be estimated based on the road surface states (road frictional force, obstacles, front road surface states, or the like) received from the probe vehicle 300 and the traffic condition statistical values. In this case, the traffic condition statistical values may use the average speed of the vehicle. In addition, the road frictional coefficient may be reduced with the increase in the average speed of the vehicle. For example, the estimating of the road frictional coefficient uses the road surface states, the average speed of the vehicle, or the like, as the input and uses the road frictional coefficient as the output.

Next, the server determines the advisory safety speed for each time and for each section by using the calculated traffic condition statistical values, the estimated road frictional coefficients, the driver's perception response time, and the TTC (S140). For example, the traffic condition statistical values such as an average speed, a median of speed, 85% of speed, a standard deviation of speed, or the like, and the road surface frictional coefficient are used as the input and the advisory safety speed for each time and for each section is used as the output. In addition, the advisory safety speed may be determined by using the traffic condition statistical values, the road surface frictional coefficient, the driver's perception response time, the TTC, the headway distance, the statistical headway distance, the minimum safety distance, the inclination, the gravity acceleration, or the like. That is, the advisory safety speed may be obtained by the following function.

Advisory Safety Speed=f (traffic condition statistical values, road surface frictional coefficient, driver's perception response time, TTC, headway distance, statistical headway distance, minimum safety distance, inclination, gravity acceleration, or the like).

As an example, the advisory safety speed may be calculated as follows. In order to avoid the collision with an escorting vehicle when the preceding vehicle is decelerated at a specific time, the escorting vehicle should be travelled at the headway distance exceeding the minimum safety distance or the escorting vehicle should be more decelerated. Therefore, the problem is caused in the case where the statistical headway distance H from the escorting vehicle at the braking time of the preceding vehicle is smaller than the minimum safety distance.

The statistical headway distance may be obtained by multiplying the TTC by the traffic condition statistical values and adding the headway distance thereto. The advisory safety speed may be determined by using the value when the minimum safety distance is the statistical headway distance. The detailed description of the exemplary embodiments of the present invention and Equations are already described.

Next, the server 100 transmits the advisory safety speed determined in the advisory safety speed determining unit 140 to the information providing apparatus 400 (S150). The information providing apparatus 400 may be the driver terminal, the variable message system, the Internet, and the broadcasting, or the like.

As set forth above, the exemplary embodiment of the present invention determines the advisory safety speed in the IT-based intelligent roads based on the real-time road conditions and the real-time vehicle travel speed such as the road surface states, the peripheral vehicle information, or the like.

Further, the exemplary embodiment of the present invention provides the advisory safety speed to the driver according to the speed information, the positional information, and the road surface states, or the like, collected from the GNSS receiver and the probe vehicle capable of performing the wireless communications, thereby making it possible to contribute to traffic safety. In addition, the exemplary embodiment of the present invention can allow a driver to lower the travel speed of a vehicle by actively coping with a traffic jam, an occurrence of an accident, rapid weather changes, or the like, thereby making it possible to contribute to the occurrence prevention of a secondary accident, the alleviation of a traffic jam, or the like.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A server of determining safety speed based on road surface states and statistical traffic conditions, comprising:
a receiver receiving real-time vehicle travel information and road surface states;
a traffic information processor calculating traffic condition statistical values for each section and for each time based on the vehicle travel information;
a road frictional coefficient estimator estimating road frictional coefficients based on the road surface states and the calculated traffic condition statistical values; and
an advisory safety speed determining unit determining safety speed for each section and for each time by using the calculated traffic condition statistical values, the estimated road frictional coefficients, a driver's perception response time, and a time to collision (TTC).

2. The server of claim 1, wherein the traffic information processor includes:
a division module dividing a collection section by mapping a vehicle position with section information for each time from the vehicle travel information; and
a calculation module calculating traffic condition statistical values for each collection section based on the vehicle travel information.

3. The server of claim 1, wherein the vehicle travel information is at least one of a vehicle id, a collection time, a speed, a position, and acceleration and deceleration.

4. The server of claim 1, wherein the calculated traffic condition statistical value is at least any one of an average speed, a median of speed, 85% of speed, and a standard deviation of speed.

5. The server of claim 1, wherein the road surface state is at least any one of dry, wet, hydroplaning, snow, freezing, mist, road frictional force, obstacles, and front road surface state.

6. The server of claim 1, wherein the estimated road frictional coefficient is small with the increase in the vehicle speed.

7. The server of claim 1, wherein the advisory safety speed determining unit determines an advisory safety speed by further using at least any one of a headway distance, a statistical headway distance, a minimum safety distance, inclination, and gravity acceleration.

8. The server of claim 7, wherein the statistical headway distance is obtained by multiplying the TTC by the traffic condition statistical values and adding the headway distance thereto.

9. The server of claim 7, wherein the advisory safety speed is determined so that the minimum safety distance becomes the statistical headway distance.

10. The server of claim 1, further comprising a transmitter transmitting the advisory safety speed.

11. A method of determining safety speed based on road surface states and statistical traffic conditions performed by a server of determining safety speed, the method comprising:
receiving real-time vehicle travel information and road surface states;
calculating traffic condition statistical values for each section and for each time based on the vehicle travel information;
estimating road frictional coefficients based on the road surface states and the calculated traffic condition statistical values; and
determining safety speed for each section and for each time by using the calculated traffic condition statistical values, the estimated road frictional coefficients, a driver's perception response time, and a time to collision (TTC).

12. The method of claim 11, wherein the calculating includes:
dividing a collection section by mapping a vehicle position with section information for each time from the vehicle travel information; and
calculating traffic condition statistical values for each collection section based on the vehicle travel information.

13. The method of claim 11, wherein the vehicle travel information is at least one of a vehicle id, a collection time, a speed, a position, and acceleration and deceleration.

14. The method of claim 11, wherein the calculated traffic condition statistical value is at least any one of an average speed, a median of speed, 85% of speed, and a standard deviation of speed.

15. The method of claim 11, wherein the road surface state is at least any one of dry, wet, hydroplaning, snow, freezing, mist, road frictional force, obstacles, and front road surface state.

16. The method of claim 11, wherein the estimated road frictional coefficient is small with the increase in the vehicle speed.

17. The method of claim 11, wherein the determining determines an advisory safety speed by further using at least any one of a headway distance, a statistical headway distance, a minimum safety distance, inclination, and gravity acceleration.

18. The method of claim 17, wherein the statistical headway distance is obtained by multiplying the TTC by the traffic condition statistical values and adding the headway distance thereto.

19. The method of claim 17, wherein the advisory safety speed is determined so that the minimum safety distance becomes the statistical headway distance.

20. The method of claim 11, further comprising transmitting the advisory safety speed.
